(19) United States
(12) Patent Application Publication
(10) Pub. No.: US 2024/0281599 A1
(43) Pub. Date: Aug. 22, 2024

(54) USER INTERFACE LEVELING FOR RENDERING NON-LINEAR DATA BASED ON A COLUMNAR FORMAT

(71) Applicant: THE BANK OF NEW YORK MELLON, New York, NY (US)

(72) Inventors: Claudio SOTO, New York, NY (US); Akashkumar DESAI, New York, NY (US); Aravind Kumar RAVINDRAN, New York, NY (US); Michal SZAFIRSKI, New York, NY (US)

(21) Appl. No.: 18/649,444

(22) Filed: Apr. 29, 2024

Related U.S. Application Data
(63) Continuation-in-part of application No. 17/967,396, filed on Oct. 17, 2022, now Pat. No. 11,923,476.

(51) Int. Cl. G06F 40/177; G06F 40/103

(52) U.S. Cl. CPC G06F 40/177; G06F 40/103

(57) ABSTRACT

The disclosure relates to user interfaces that reconcile non-linear data and a table format to display the non-linear data across various screen sizes without loss of information. A system may access non-linear data such as a hierarchical data structure. The system may access a plurality of data elements that represent the non-linear data for rendering in a display container, which has a display height that varies depending on the screen size of a given display device. The system may obtain the available display height and determine a number of columns to render based on the display height and the plurality of data elements. The system may fill the columns with the plurality of data elements using a columnar format that maintains contiguity of groups of data elements that span more than one column. The system may configure a patch to visually indicate the contiguity.

### CROSS-REFERENCE TO RELATED APPLICATIONS

This application is a continuation-in-part of U.S. patent application Ser. No. 17/967,386, filed Oct. 17, 2022, entitled “TRANSFORMATION OF HIERARCHICAL DATA STRUCTURE INTO A GRID PATTERN,” which is incorporated by reference in its entirety herein.

### BACKGROUND

Data is oftentimes organized into hierarchical data structures to represent relationships between different hierarchical layers. For example, a tree data structure may represent hierarchical relationships such as genealogical histories, employee organization charts, and others. These and other types of hierarchical data structures may store data in a way that preserves hierarchical relationships. Because the hierarchical relationships may branch in different directions and include multiple hierarchical levels, hierarchical data structures may exhibit non-linearity. This non-linearity may cause issues when rendering displays for presenting the data.

For example, the amount of hierarchical data may be larger than what screens can meaningfully display. To limit the amount of display space hierarchical data structures occupy, some rendering systems may generate hierarchical displays that require user interactions such as by clicking on different nodes to reveal nested data. However, these rendering systems necessarily require inefficient interface control and may result in obscuring nested data, which may include pertinent alert data. These and other issues may be exacerbated when the hierarchical data is updated in real-time, necessitating dynamically generated displays that may be unable to meaningfully present the updated data. Though these and other issues typically occur for smaller screen sizes such as on mobile devices, they can also occur for larger screen sizes such as television and projection images depending on the amount and non-linearity of hierarchical data to be displayed.

Furthermore, when building user-friendly dashboards that involve large amounts of data, tables are commonly used to present the data logically. However, in many instances, these dashboards may present data in a way that negatively impacts user experience, especially when the dataset is large. This is because of the variation in screen sizes can make it difficult to present large amounts of data in a way that is easy to find. For example, different screen sizes may involve a different amount of scrolling. These and other issues may exist when rendering displays for hierarchical data or otherwise large datasets.

### SUMMARY

Various systems and methods may address the foregoing and other problems. For example, a system may reconcile non-linear data and a table format without losing any data and showing clear outlining on the groups and internal groups. To facilitate reconciliation, the system may transform non-linear data, such as a hierarchical data structure, into a columnar format. The columnar format is a pattern having multiple columns with each column having one or more tables that can span multiple columns. Thus, one or more nested tables may be placed into a single column, and a given one of the nested tables may span two or more columns to efficiently use display space while maintaining logical groupings of the non-linear data. Each of the nested tables may include one or more rows. Each of these rows may be used to display a respective data element. A data element is data that represents non-linear data. For example, a data element may represent a node such as a root node, a parent node, or a leaf node of the hierarchical data structure. Each row in a given column of the columnar format may have a uniform row height within a column. That is, each row may occupy the same height in the display container as other rows in the column. Each row may also have a uniform row height across other columns.

To render the hierarchical data structure into the columnar format, the system may determine a total height of height-spacing elements in a display container. Height-spacing elements are elements such as rows, headers, paddings, and margins that occupy vertical space in the display container. For example, the total height may be based on the row heights of the plurality of data elements and any vertical paddings and margins of the tables to be rendered if the data elements were lined up in a single column.

The system may determine a number of columns to use in the columnar format. The number of columns may be based on the size of the input data from the plurality of nodes and the available display height of a display container. For example, the number of columns may be based on the total pixel height divided by the available display height, rounded up to the nearest whole integer. In some instances, a parameter that specifies the maximum number of columns to use may be inputted to the system. In these instances, the system may use the lesser of the determined number of columns and the maximum number.

The method may fill the columns (up to the determined or maximum number) with the plurality of data elements. Filling will involve rendering data from the hierarchical data structure into respective rows of each column until each of the data has been rendered. Filling may also involve maintaining columns at even height with one another to minimize empty space and maximize use of available space in the display container.

When a row or a header cannot be filled into a current column, the system may determine whether the row or header should be moved to the next column based on one or more empiric constraints. For example, filling may include maintaining a current height of a column being filled based on the height spacing elements that have been added or will need to be added based on the data elements that have been filled in the column.

If a table is split across two or more columns, such as when the data elements in a group or header do not fit in the current column, then the system may apply a patch based on a patch direction that specifies the location at which the patch connecting columns should be applied. When the two last columns are reached and if there are rows that won't fill into the last column, the system may evenly fill the last two columns consistent with the rest of the columnar format to give an appears of even height across the entire columnar format. The system may apply the patch between columns to maintain contiguous groups that span multiple columns. Patches may be applied in a patch direction. The patch direction refers to a location at which the patch is applied.

To determine the patch direction, the system may include determine whether the current column being filled is split (such as if a data element of table in the column will not fit). If so, the system may determine the available height remaining in the current column and the height moved to the next column. If the available height in the current column is greater than the height moved to the next column, then the patch is applied to the left of the next column. Otherwise, the patch is applied to the right of the current column. The system may also determine whether the column to which the patch is applied is an odd numbered or even numbered column. Oddness or evenness alternates every other column. The patch may be applied to the top of the column for even numbered columns and to the bottom of the column for odd numbered columns (top for even next column and patch left on the next column, bottom for odd current column and patch right of the current column, top for even current column and patch right on the current column, bottom for odd next column and patch left of the next column). The patch height may be configured by the client (such as a browser) dynamically according to CSS style set on the table.

Once the columnar format is generated, the data in the columnar format may be displayed in an electronic device that displays the display container.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system for transforming hierarchical data structures into a view layer having a grid pattern;

FIG. 2 illustrates an example of a hierarchical data structure (such as a tree structure) transformed into a grid pattern layer;

FIG. 3 illustrates examples of grid patterns and spacing between grid elements;

FIG. 4 illustrates an example of a method of transforming a hierarchical data structure into a grid pattern layer;

FIG. 5 illustrates an example of equally spacing cells representing leaf nodes in a grid pattern layer;

FIG. 6 illustrates another example of spacing of leaf nodes in a grid pattern layer;

FIG. 7A illustrates an example of a part of a progression of laying out hierarchical data into a grid;

FIG. 7B illustrates an example of another part of a progression of laying out hierarchical data into a grid;

FIG. 7C illustrates an example of another part of a progression of laying out hierarchical data into a grid;

FIG. 7D illustrates an example of another part of a progression of laying out hierarchical data into a grid;

FIG. 7E illustrates an example of another part of a progression of laying out hierarchical data into a grid;

FIG. 7F illustrates different examples of layout patterns for laying out hierarchical data into a grid;

FIG. 8 illustrates an example of a method of laying out a set of data in a presentation layer representing a hierarchical data structure into a grid;

FIG. 9 illustrates an example of a hierarchical data structure (such as a tree structure) transformed into a columnar format;

FIG. 10 illustrates an example of a method of laying out a set of data in a presentation layer representing a hierarchical data structure based on the columnar format;

FIG. 11A illustrates an example of a part of a progression of laying out hierarchical data into the columnar format;

FIG. 11B illustrates an example of another part of a progression of laying out hierarchical data into the columnar format;

FIG. 11C illustrates an example of another part of a progression of laying out hierarchical data into the columnar format;

FIG. 11D illustrates an example of another part of a progression of laying out hierarchical data into the columnar format; and

FIG. 12 illustrates an example of a method of generating a user interface display that represents a hierarchical data structure into a columnar format.

### DETAILED DESCRIPTION

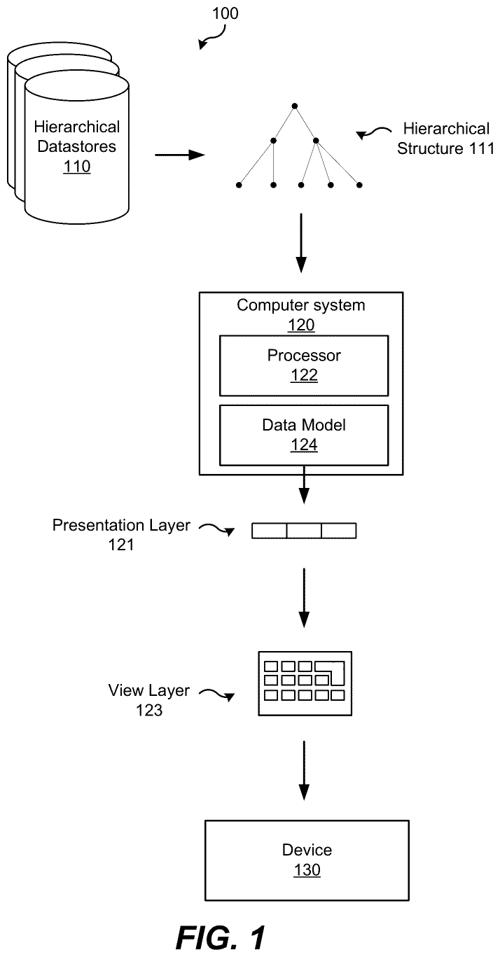

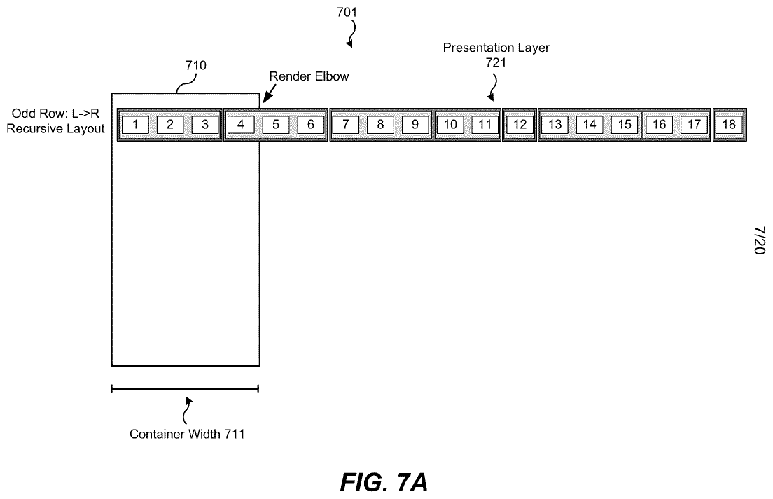

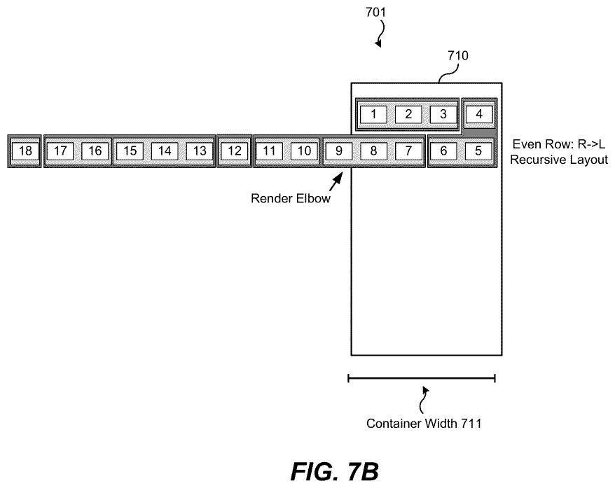

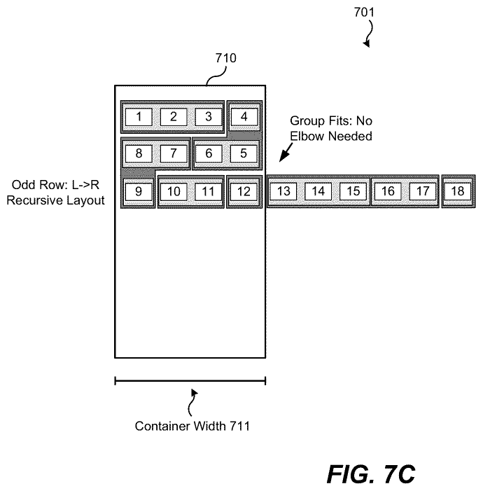

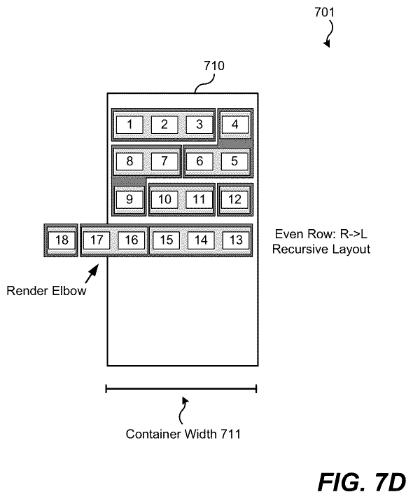

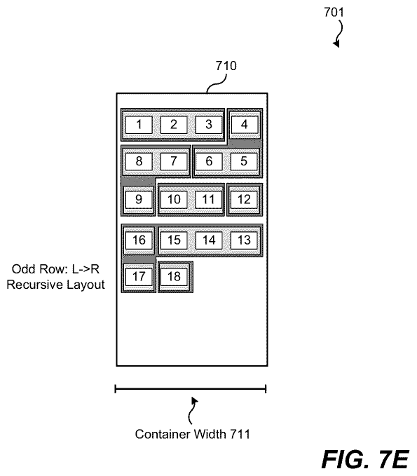

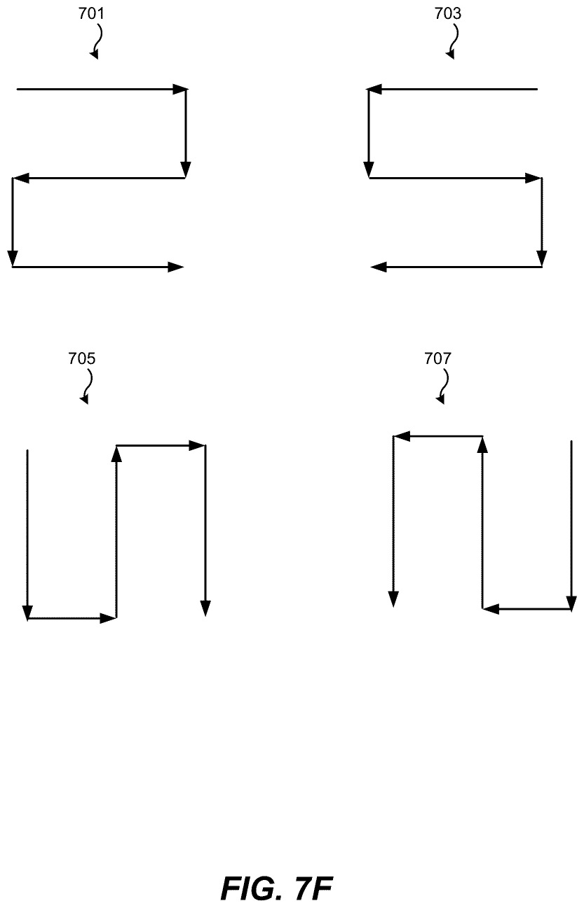

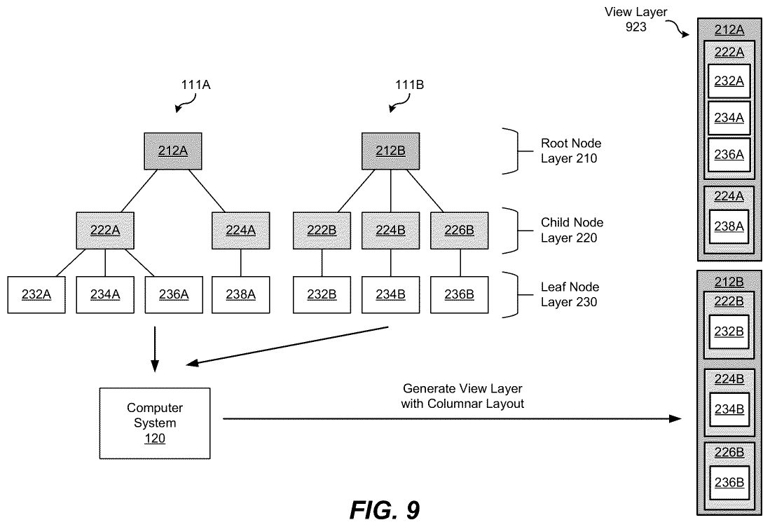

FIG. 1 illustrates an example of a system 100 for transforming hierarchical data structures 111 into a view layer 123 (also depicted as view layer 923 in FIG. 9) having a grid pattern. In some examples, the grid pattern may use a grid pattern format as illustrated in FIGS. 7A-7E or a columnar format as illustrated in FIGS. 9A-9D. The system 100 may include hierarchical datastore 110, a computer system 120, a device 130, and/or other features. The hierarchical datastore 110 may store hierarchical data structures 111. A hierarchical data structure 111 may refer to data that is stored in a way that is linked to one another to maintain hierarchical relationships. For example, a hierarchical data structure 111 may link data together in parent-child relationships. These parent-child relationships may be recursive in that there may be multiple generations, or hierarchical layers, of the hierarchical data structure 111. It should be noted that node-link diagrams are used throughout to represent a hierarchical data structure (such as hierarchical data structure 111) for illustration. Other types of diagrams may represent the hierarchical data structure 111. Furthermore, root nodes are illustrated as being on a “top” node layer in which the tree nodes radiate downward to the leaf nodes. However, the representation may include root nodes being on a “bottom” node layer such that the tree nodes radiate upward to the leaf nodes. The examples described herein are therefore used for illustrating modeling hierarchical relationships in hierarchical data structures in a grid pattern.

An example of a hierarchical data structure 111 includes a tree data structure. A tree data structure may refer to a collection of nodes having parent-child relationships. A node may represent a data value, which may hold a state. The state refers to a current condition of the node, such as a user interaction, data update, and/or other data indicating a current value. A node may be connected to another node by an edge. An edge refers to a logical connection between two nodes. In some examples, an edge may hold state. An edge may link nodes a parent-child relationship-though sibling relationships are possible. In some examples, each node has a single parent but may have one or more child nodes. Each node is connected to its child nodes via edges.

A parent node is an immediate predecessor of a node. As used herein, a parent node may also be referred to as a “group.” A child node may refer to a successor of a parent node. A root node may refer to a top level node that has no parents. As such, a tree data structure may originate at the root node. A leaf node may refer to a node that has no children. The leaf node may hold state. A node level may refer to the number of edges along a unique path traversing up the tree between a node at the node level and the root node. In some examples, only the leaf node will include data for display. In some examples, leaf nodes will be on the same level as one another. In these examples, leaf nodes will be the same distance to a root node in a tree data structure.

The computer system 120 may include access one or more hierarchical data structures 111 and transform the one or more hierarchical data structures 111 into a view layer 123 having a grid pattern for display on the device 130. To do so, the computer system 120 may include one or more processors 122, a data model 124, and/or other components. The processor 122 may include one or more of a digital processor, an analog processor, a digital circuit designed to process information, an analog circuit designed to process information, a state machine, and/or other mechanisms for electronically processing information. Although processor 122 is shown in FIG. 1 as a single entity, this is for illustrative purposes only. In some embodiments, processor 122 may comprise a plurality of processing units. These processing units may be physically located within the same device, or processor 122 may represent processing functionality of a plurality of devices operating in coordination.

The processor 122 is programmed to execute one or more computer program components. The computer program components may include software programs and/or algorithms coded and/or otherwise embedded in processor 122, for example. The one or more computer program components or features may include a data model 124 and/or other components or functionality. Processor 122 may be configured to execute or implement the data model 124 by software; hardware; firmware; some combination of software, hardware, and/or firmware; and/or other mechanisms for configuring processing capabilities on processor 122.

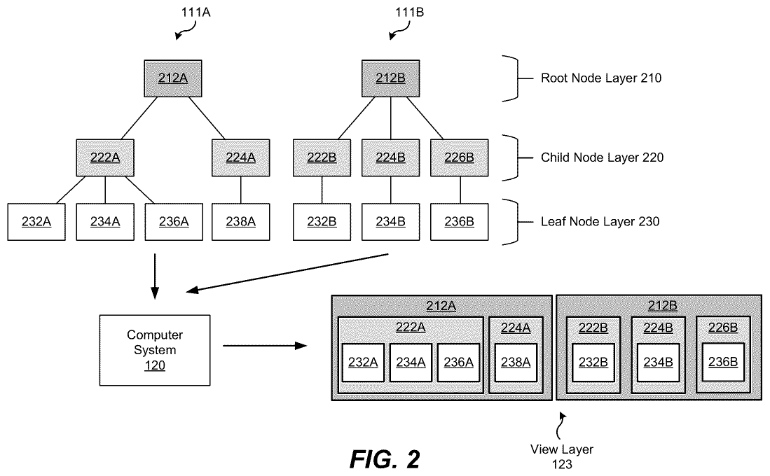

The data model 124 may take as input a hierarchical data structure 111, compute a layout of nodes in the hierarchical data structure 111 and generate a presentation layer 121 that is consumed by the view layer 123 having a grid pattern for display at the device 130. Various operations of the data model 124 and illustrations made for clarity are discussed with respect to FIGS. 2-9.

FIG. 2 illustrates an example 200 of hierarchical data structures 111A and 111B transformed into a view layer 123 having a grid pattern. Two hierarchical data structures 111A and 111B are shown for clarity. However, other numbers of hierarchical data structures 111 may be transformed into a grid pattern, including one or more than two hierarchical data structures. As illustrated, hierarchical data structure 111A and 111B each include a root node layer 210, a child node layer 220, and a leaf node layer 230. The root node layer 210 includes a root node 212A and 212B. If should be noted that the illustrated child nodes (222A, 224A, 222B, 224B, 226B) in child node layer 220 are also parents to respective leaf nodes (232A, 234A, 236A, 238A, 232B, 234B, 236B) in leaf node layer 230. Other numbers of node levels and nodes may be transformed instead or as well. The example 200 shows the layout of the various nodes in the hierarchical data structures 111A and 111B.

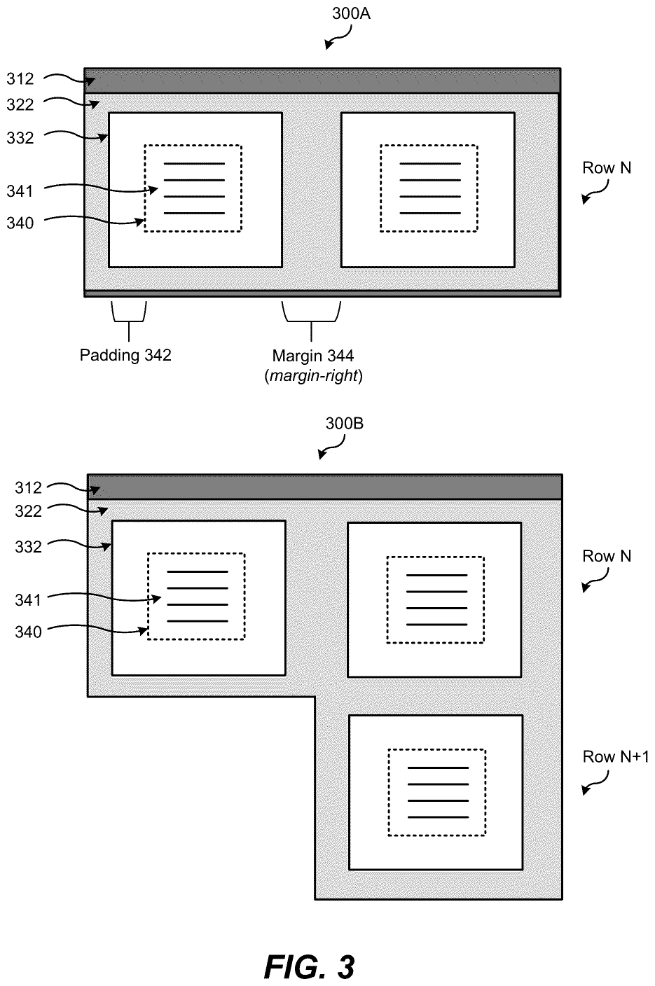

FIG. 3 illustrates examples of grid patterns 300A and 300B and presentation data (such as a padding 342 and a margin 344) between grid elements. Grid pattern 300A illustrates a simplified example of a hierarchical data structure that was transformed into a grid pattern for display. For example, group 312 may represent a root node. Cell 322 may represent a child node of the root node. Cell 332 may represent a leaf node of the child node. Each of the group 312, cell 322, and cell 332 may occupy display space that is defined by an outline (illustrated as a bounding box, although other bounding shapes may be used). The outline may be visible or invisible in a display. The cell 332 may include content 341, such as state information, of the leaf node. The content may be within a content boundary 340, which is illustrated in dashed lines.

Padding 342 defines a spacing between the content boundary 340 and the boundary of the cell 332. Margin 344 defines an amount of space between a position in a row at which a boundary of an element (such as a group 312, cell 322, or cell 332) is located. The illustrated margin 344 shows an example of a margin-right property for cell 332 that defines an amount of space on the right side of the cell 332 before a next element (cell) can be placed. Other types of margins 344 (such as a margin-left) may be used depending on the configuration of the layout. It should be further noted that a top and/or bottom margin may be determined for spacing between rows in the grid pattern. As will be described below, the spacing of the grid elements (such as via padding 342 and/or margin 344) may be dynamically determined for layout purposes and may be made equal across the grid pattern to improve readability and consistency. Reference to left, right, top, and bottom may refer to directionality of a display as it is intended to be read by a user facing a display.

In some examples, as node levels in a hierarchical data structure 111 are traversed, the corresponding group 312, cell 322 and cell 332 (and/or other cells) may be displayed differently, such as having different shading, color, and/or other visually distinguishing characteristics. As illustrated, traversing from a root node (group 312) to a leaf node (cell 332), the shading becomes lighter. In other examples not illustrated, traversing from a root node (group 312) to a leaf node (cell 332), the shading may become darker. This may further facilitate improved viewing of the hierarchical data structure 111 in a grid pattern.

Grid pattern 300B illustrates a simplified example of a hierarchical data structure that was transformed into a grid pattern for display with an elbow feature. The elbow display occurs when display space occupied by a group (such as group 312 as illustrated) exceeds available space in a row. The computer system 120 in this instance may flow the group the next row with a continuous display feature to indicate overflowed portion in the next row is part of the group.

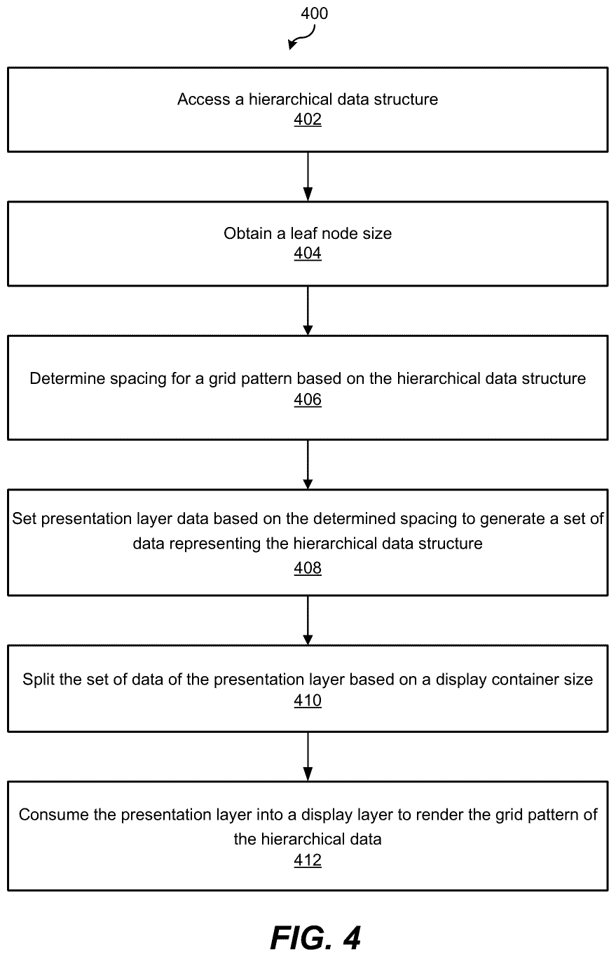

FIG. 4 illustrates an example of a method 400 of transforming a hierarchical data structure 111 into a grid pattern display.

At 402, the method 400 may include accessing a hierarchical data structure (such as a hierarchical data structure 111). In some examples, the hierarchical data structure may be accessed in various data objects or formats that convey hierarchical relationships, such as distributed arrays, native data structures, and/or other techniques. Examples of native data structures may include JAVASCRIPT Object Notation (JSON) tree data, extensible markup language (XML), and/or other built-in hierarchical ways to convey hierarchical data.

At 404, the method 400 may include obtaining a leaf node size. The leaf node size may refer to an amount of display space to be occupied in a grid pattern by a corresponding leaf node of the hierarchical data structure. For example, the leaf node size may be an amount of display space that is allocated to the cell 332 in the grid pattern. In particular, the leaf node size may include dimensions such as width and height in the display space. The display size (or its dimensions) may be expressed in absolute display units such as a number of pixels or relative display units such as a ratio. In some examples, the leaf node size may be subject to a minimum size in which case the leaf node size will be at least the minimum size. In some examples, the leaf node size may be subject to a maximum size in which case the leaf node size will be at most the maximum size.

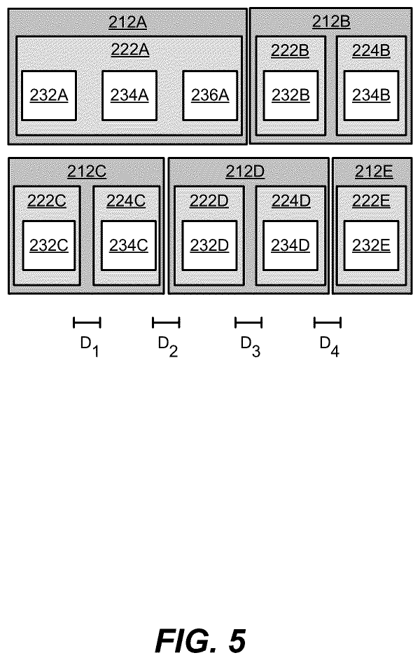

At 406, the method 400 may include determining spacing for a grid pattern based on the hierarchical data structure. The spacing may define placement of the one or more cells and one or more groups in the grid pattern in a way that achieves the same distance between cells that represent leaf nodes, regardless of the node level at which a leaf node is located. For example, FIG. 5 illustrates an example of equally spacing cells representing leaf nodes in a grid pattern display. As illustrated, group 212A (corresponding to a root node) includes a cells 222A (corresponding to a child node). Cells 222A has nested therein cells 232A, 234A, and 236A (each corresponding to a leaf node). Group 212B (corresponding to another root node) includes cells 222B and 224B (each corresponding to a child node). These cells 222B and 224B respectively have nested therein cells 232B and 234B (each corresponding to a leaf node). Group 212C (corresponding to yet another root node) includes cells 222C and 224C (each corresponding to a child node). These cells 222C and 224C respectively have nested therein cells 232C and 234C (each corresponding to a leaf node). Group 212D (corresponding to another root node) includes cells 222D and 224D (each corresponding to a child node). These cells 222D and 224D respectively have nested therein cells 232D and 234D (each corresponding to a leaf node). Group 212E (corresponding to another root node) includes a cell 222E (corresponding to a child node). Cell 222E has nested therein a cell 232E (corresponding to a leaf node). Distances between each of the leaf nodes may be equal to one another. For example, distances D1-D4 may be equal to one another so that there is uniform spacing between leaf nodes. Regardless of where a given leaf node is in a hierarchical data structure, its cell representation in a grid pattern will be equally spaced from another cell, which represents another leaf node. For example, as shown, spacing given by distances D1-D4 are equal to one another.

To determine a margin, the method 400 may include determining a distance between two nodes that do not share a common ancestor other than a root node. The base margin without any calculation, these two nodes will determine the distance between leaf nodes since this distance is the largest distance that two leaf nodes would have had between them.

Depending on the node level at which a node being laid out is located, different margins may be applied. For example, different sizes of margins for a node may be used depending on its node level. The difference in margins applied per node level may ensure that a consistent grid pattern is rendered with uniform spacing. The higher the level of the node (the more nested a node is), a larger margin may be used. For example, leaf nodes may be spaced apart from one another more so than parent nodes are spaced apart from one another, as illustrated in FIG. 5.

For data elements at the right-most position of their parent (they are the last child), their margin-right may be set to zero. For other nodes and direct children of the root node, their margin-right may be determined based on Equation 1:

$$Margin - right = 2 \times ( NL - 1 ) \times bp + bm , \qquad ( 1 )$$

In which:
NL=node level,
bp=a predefined, configurable, base padding value, and
bm=a predefined, configurable, base margin value.

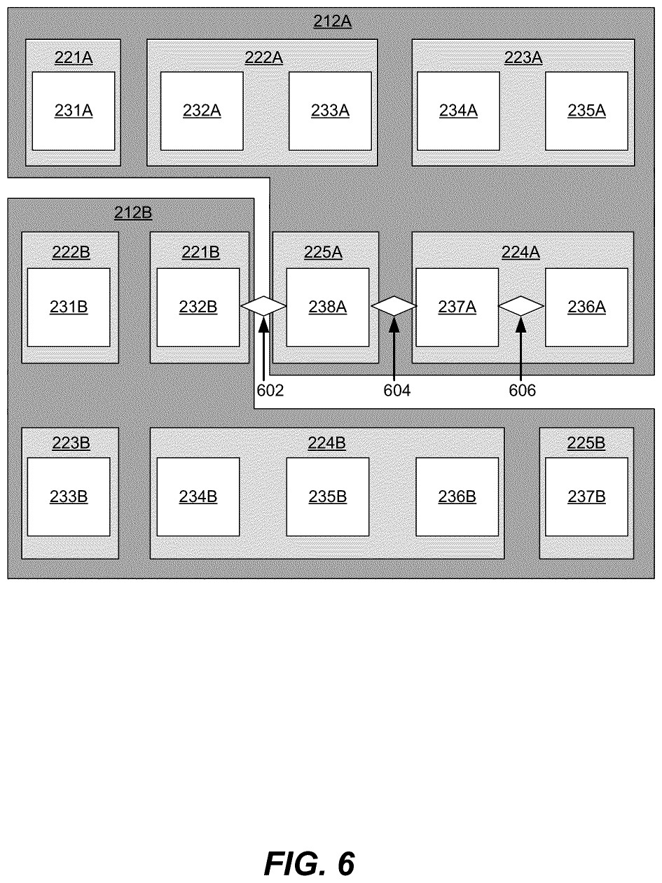

In the example of Equation (1), left margins are not used and spacing relies upon the right margin. In other examples, left margins may be determined and right margins are not used, using appropriate transformations of Equation 1 to determine left instead of right margins. It should be noted that a sum of paddings (given by 2×(NL−1)×bp) may be applied to parent groupings in order to generate a consistently-spaced grid pattern with uniform spacing. It should be further noted that a margin (bm) may be applied to the direct children of a root node. Examples of determining margins for spacing leaf nodes in a grid pattern display are described with reference to FIG. 6, which illustrates an example of leaf node spacing in a grid pattern display. Referring to FIG. 6, as illustrated, group 212A (corresponding to a root node) includes cells 222A-225A (each corresponding to a child node). These cells 221A-225A respectively have nested therein cells 231A-238A (each corresponding to a leaf node). Group 212B (corresponding to another root node) includes cells 221B-225B (each corresponding to a child node). These cells 221B-225B respectively have nested therein cells 231B-237B (each corresponding to a leaf node). Distances between each of the leaf nodes may be equal to one another. The determination of distances 602, 604, and 606 are illustrated using a base margin of 4 pixels (px) and a base padding of 1 px.

### For Distance 602:

1. Node 232B-right padding: 1px (bp) (margin=0 as it is positioned at the end of its parent).
2. Node 221B-right padding: 1px (bp) (as it is positioned at the end of its parent).
3. Node 212B (group)-Parent of 221B-right margin (name not visible in the image): n1=1=>(2*(0)*1)+4=4px.
4. Node 212B-1px (bp) (as it is positioned at the end of its parent).
5. Node 212A (group)-left padding (name not visible in the image): 1px (bp)
6. Node 225A-left padding: 1px (bp).
7. Node 238A-left padding: 1px (bp).
8. Total: 10px

### For Distance 604:

1. Node 238A-right padding: 1px (bp) (margin=0 as it is
positioned at the end of its parent).
2. Node 225A-right padding: 1px (bp)
3. Node 225A-right margin: n1=2=>(2*(1)*1)+4=6px
4. Node 224A: 1px (bp).
5. Node 237A: 1px (bp).
6. Node Total: 10px

### For Distance 606:

1. Node 237A-right padding: 1px (bp).
2. Node 237A-right margin: n1=3=>(2*(2)*1)+4=8px
3. Node 236A: 1px (bp).
4. Total: 10px

At 408, the method 400 may include setting presentation layer data based on the determined spacing to generate a set of data representing the hierarchical data structure. Presentation layer data may include the width, height, padding, margin, and/or other data for a given group (root node) or cell (other nodes). To set the presentation layer data, the method 400 may include recursively iterating through data elements that represent the nodes and setting their values based on the padding and margin determined for each. In this manner, each data element representing a node may have its presentation layer data set, which may be stored as part of its state. In some examples, after such iterative processing, the presentation layer will be rendered as a set of data elements with x-positions in the row based on the padding and margin data for the nodes. Each data element in the set of data elements may include attributes, metadata, and/or other data that may be used to identify a position in the view layer at which the data is to be rendered.

At 410, the method 400 may include splitting the set of data elements in the presentation layer based on a size of a display container within which the view layer will be rendered. The size may include a width and/or height, which may be expressed in pixels, unit of length, and/or other measurement. For example, to split the row, the method 400 may include recursively placing data elements in the single row of the presentation layer until further elements will no longer fit within the width of the display container. FIGS. 7A-7E shows an example progression of splitting a row of data elements in a presentation layer 721 based on a size of a display container 710 having a container width 711. In FIGS. 7A-7E, three node levels are shown with the same shading as shown in FIG. 3 to represent root nodes, parent nodes, and leaf nodes with reference number omitted for the root and parent nodes. Data elements representing leaf nodes are labeled 1-18 to show an example of laying out the leaf nodes in the grid pattern.

Referring to FIG. 7A, the method 400 may include laying out the elements of the presentation layer 721 based on a layout pattern 701 in which the elements are laid out starting from the left (as intended to be perceived by a reader) of the display container 710 and proceeding to the right. A root node has leaf nodes 4-6 in which leaf nodes 5 and 6 overflow the container width 711. As such, the nodes 4-6 of the root node will be split across different rows. These split nodes may be added to a list of components to be placed in the display container 710 with an indication of the split. For example, each of the leaf nodes will be stored with attributes such as their width and metadata to indicate that these nodes are to be visually grouped together across rows when rendering the view layer. Such visual grouping may be indicated by the same group shading, coloring, or other visual indication of a group. In particular, an elbow will be rendered at the point of overflow. Referring to FIG. 7B, the leaf nodes 4, 5, and 6 are split at the elbow and the visual indication includes the same shading for the group (which represents the root node to which the leaf nodes 4, 5, and 6 ultimately belong). In this way, even though the leaf nodes 4-6 are split across different rows, they are easily identifiable as belonging to the same root node group. In the layout pattern 701, odd rows in the view layer may have elements laid out from left-to-right and even rows may have elements laid out from right-to-left, as illustrated in the progression of FIGS. 7A-7E. As illustrated, the ordering of elements are appropriately inverted when switching between odd and even rows. Metadata for each of the elements may be updated to reflect this ordering. For example, the margin-right may be transformed to a margin-left to ensure proper layout when switching from odd rows to even rows. It should be noted that an elbow may not be necessary when switching to a new row, such as illustrated in FIGS. 7C and 7D. It should also be noted that 410 may involve updating element attributes and metadata of the presentation layer 721 and the actual visual rendering may occur at 412.

At 412, the method 400 may include consuming the presentation layer into a display layer to render a grid pattern of the hierarchical data. Once the presentation layer data has been set at 410, the view layer may be rendered. For example, the presentation layer data (such as width, height, margin, and so forth) may be rendered into a display. To do so, groups may be rendered recursively. When a group renders its child nodes, the child nodes will render its own child in the same way, and so on, until the end of the tree is reached at the leaf nodes. As previously noted, to show the hierarchy within the tree, distinguishing visual characteristics may be used. For example, the background color of the nodes is modified (from a configurable base color) so that any node gets a little lighter (or darker if configured) than its parent. It should be noted that if the number of rows in the grid exceed a height of the display container, a scroll item may be used.

The layout pattern 701 is described for convenience. Other layout patterns may be used as well or instead. For example, FIG. 7F shows difference examples of layout patterns. Layout pattern 701 shows the pattern illustrated in FIGS. 7A-E. Layout patterns 703, 705, and 707 may be used instead. These layout patterns 703, 705, and 707 are shown to illustrate different types of layout patterns that may be used. Still other layout patterns not illustrated may be used as well, such as generally starting from the bottom to top (layout patterns 701, 703, 705, and 707 generally start from the top to bottom).

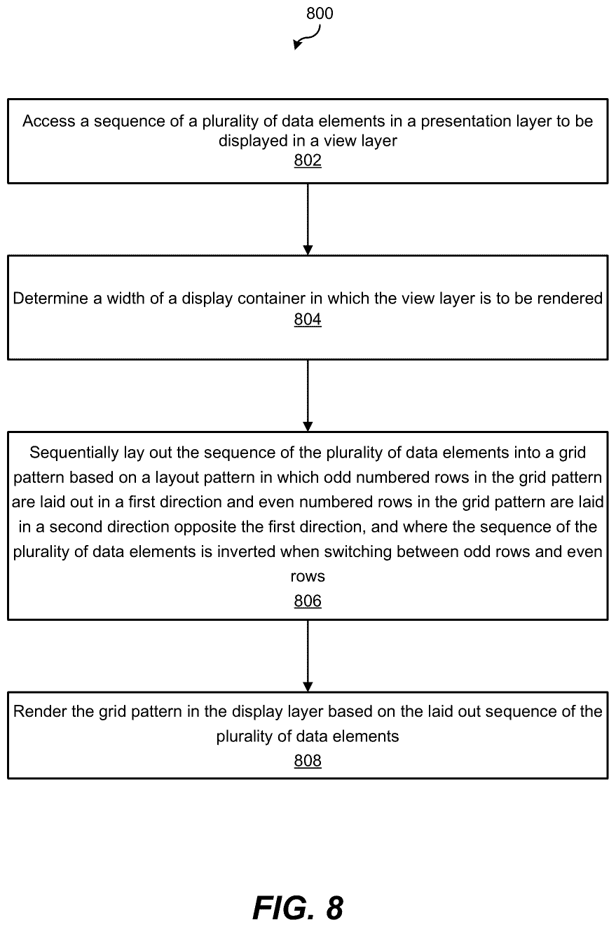

FIG. 8 illustrates an example of a method 800 of laying out a set of data in a presentation layer representing a hierarchical data structure into a grid. At 802, the method 800 may include accessing a sequence of a plurality of elements in a presentation layer to be displayed in a view layer 123. For example, each element may represent a node (root node, parent node, and/or leaf node) in a hierarchical data structure 111. The hierarchical data structure 111 may therefore be rendered for display via the view layer 123. At 804, the method 800 may include determining a width of a display container in which the view layer is to be rendered. The display container may be dynamically resized, which may result in repeating method 800 to dynamically re-render the hierarchical data structure 111. At 806, the method 800 may include sequentially laying out the sequence of the plurality of elements in a grid based on a layout pattern in which odd numbered rows in the grid pattern are laid out in a first direction and even numbered rows in the grid pattern are laid in a second direction opposite the first direction, and where the sequence of the plurality of elements is inverted when switching between odd rows and even rows. An example of laying out the elements in a grid is shown in FIGS. 7A-7E. FIG. 7F illustrates different examples of layout patterns that may be used during the layout process illustrated in FIGS. 7A-7E. At 808, the method 800 may include rendering the grid in the view layer 123 based on the laid out sequence of the plurality of elements.

FIG. 9 illustrates an example of a hierarchical data structure (such as a tree structure) transformed into a columnar format. Two hierarchical data structures 111A and 111B are shown for clarity. However, other numbers of hierarchical data structures 111 may be transformed into the columnar pattern, including one or more (other than two) hierarchical data structures. As illustrated, hierarchical data structure 111A and 111B each include a root node layer 210, a child node layer 220, and a leaf node layer 230. The root node layer 210 includes a root node 212A and 212B. If should be noted that the illustrated child nodes (222A, 224A, 222B, 224B, 226B) in child node layer 220 are also parents to respective leaf nodes (232A, 234A, 236A, 238A, 232B, 234B, 236B) in leaf node layer 230. Other numbers of node levels and nodes may be transformed instead or as well. The example 200 shows the layout of the various nodes in the hierarchical data structures 111A and 111B transformed into a view layer 923 for generating a columnar format.

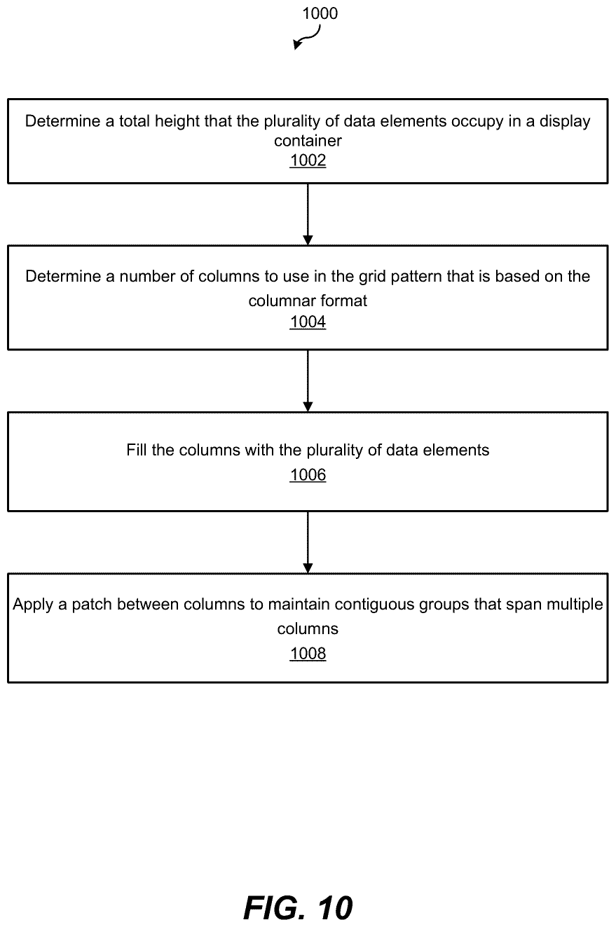

FIG. 10 illustrates an example of a method 1000 of laying out a set of data in a presentation layer representing a hierarchical data structure into the columnar format. At 1002, the method 1000 may include determining a total height that the plurality of data elements occupy in a display container. The plurality of data elements may represent nodes from a hierarchical data structure, such as the nodes 212A,B, 222-226, and 232-238 in the hierarchical data structure 111A and 111B transformed into the view layer 923 illustrated in FIG. 9. Each node (the data element representing each node) may be displayed as a cell in a table, which may be displayed using various technologies such as CSS or other display technology.

The total height may be based on a sum of height-spacing elements that each occupy a certain height, such as number of pixels. Height-spacing elements may be based on the number of rows, the number of headers, number of split columns, height of each row, height of each header, top and bottom margins of the table, top and bottom paddings of the table, and/or other height-spacing elements. In some examples, the table margins and/or paddings may be configurable and provided as an input.

For purposes of determining the total height, each row may be a conventional table row that occupies a display space having a certain height, such as number of pixels. Each row may represent the data contained in leaf nodes. Thus, a row in this context may be used to display the data of a corresponding leaf node. A header may represent a node, such as a root node or a parent node, that is not a leaf node. Each header may include the name of the root node or parent node, and be followed by one or more rows represented by respective leaf nodes or one or more other headers. A header may occupy display space having the same height as a row. In these examples, headers and rows have consistent spacing. A split column is one in which data elements of a group of nodes do not fit in a single column and therefore is split across two or more columns. Paddings and margins refer to spacing of table elements such as table cells. Examples of paddings and margins are described with respect to padding 342 and margin 344 in FIG. 3.

To illustrate, the total height may include summing all of the heights spacing elements (H1 through H4), in which “*” denotes multiplication and each header is implemented as an HTML/CSS table with one or more margins and one or more paddings:
H1=Total number of rows (such as the number of data elements)*pixel height of each row
H2=Total number of headers*pixel height of each header+margin between tables+table padding) (in which headers and its children are implemented as individual tables).
H3=Number of split columns*table paddings.
H4=Number of split columns*table margins.

At 1004, the method 1000 may include determining a number of columns to use in the columnar format. The number of columns may be based on the size of the input data from the plurality of nodes and the available display height of a display container. In particular, the number of columns (C) may be based on the total pixel height determined at 1002 and the available display height, such as given by Equation 2:

$$C = \frac{total pixel height}{available display height} . \qquad ( 2 )$$

In Equation (2), C may be rounded up to the nearest whole integer. In some examples, C may be constrained by a maximum number of columns, which may be input by a user and/or set to a default value. In these examples, the lesser of the rounded C from equation (1) and maximum number of columns may be used.

At 1006, the method 1000 may include filling the columns (up to C) with the plurality of data elements. Filling will involve rendering data from the hierarchical data structure into respective rows of each column until each of the data has been rendered. Filling will involve maintaining columns at even height with one another to minimize empty space and maximize use of available space in the display container.

In one example of filling, the method 1000 may include iterating through the hierarchical data, and stepping through each node until leaf nodes are reached. Root or parent nodes may be rendered as a group and each parent node that has children nodes may be rendered as a header. Leaf nodes may be rendered as rows that are logically part of a header, which may be logically part of a group.

When a row or a header cannot be filled into a current column, the method 1000 may include determining whether the row or header should be moved to the next column based on one or more empiric constraints. For example, filling may include maintaining a current height of a column being filled based on the height spacing elements (such as one or more of H1 through H4) that have been added or will need to be added based on the data elements that have been filled in the column. The empiric constraints may include the number of determined columns and/or any maximum number of columns that may have been provided as input.

If a table is split across two or more columns, such as when the data elements in a group or header do not fit in the current column, then the method 1000 may apply a patch based on a patch direction that specifies the location at which the patch connecting columns should be applied. The patch height may be configured by the client (such as a browser) dynamically according to CSS style set on the table. Further details of a patch are described at 1008.

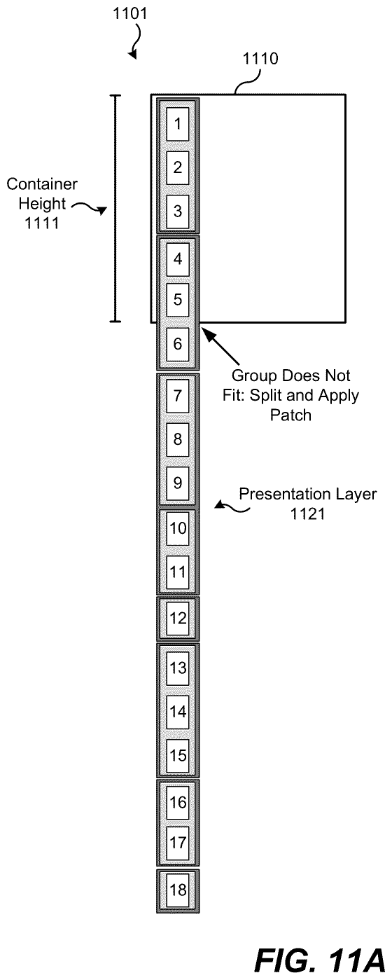

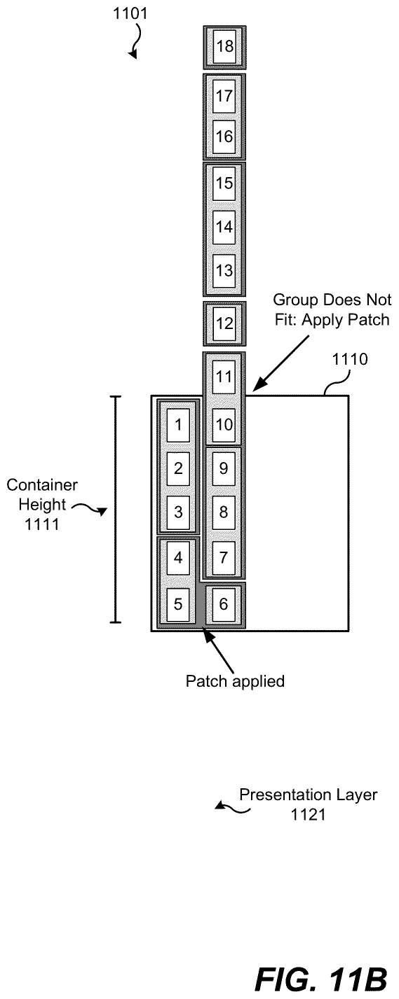

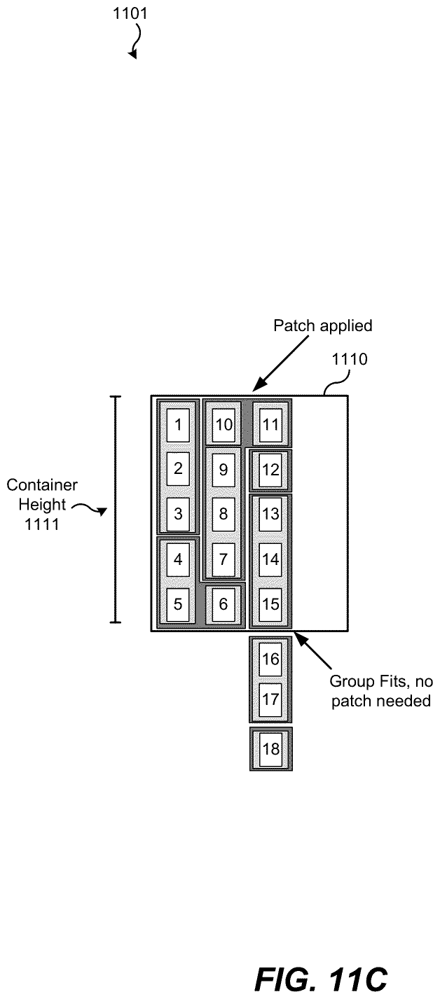

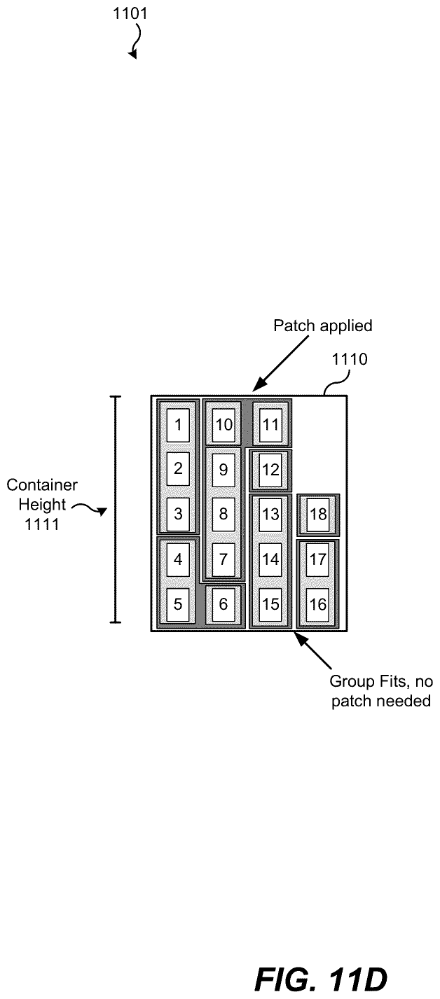

When the two last columns are reached and if there are rows that won't fill into the last column, then the method 1000 may evenly fill the last two columns consistent with the rest of the columnar format to give an appearance of even height across the entire columnar format. In some edge cases, there may be a row and/or header remaining, in which case that row and/or header will be added to the last column. An example of filling the columns through a layout progression is illustrated in FIGS. 11A-11D.

At 1008, the method 1000 may include applying a patch between columns to maintain contiguous groups that span multiple columns. Patches may be applied in a patch direction. The patch direction refers to a location at which the patch is applied. For example, the patch direction may include: (D1) top left, (D2) top right, (D3) bottom left, and (D4) bottom right location of a column at which to apply the patch. If there is not a column split between a given pair of columns, then no patch will be applied in any direction.

The direction of the patch (such as directions D(1)-D(4)) may be determined during the filling phase described at 1006 and elaborated upon here. For example, to determine the patch direction, the method 1000 may include determining whether the current column being filled is split. If so, then the method 1000 may include determining the available height (such as pixels) remaining in the current column and the height (number of pixels) moved to the next column. If the available height in the current column is greater than the height moved to the next column, then the patch is applied to the left of the next column. Otherwise, the patch is applied to the right of the current column. The method 1000 may include determining whether the column to which the patch is applied is an odd numbered or even numbered column. Oddness or evenness alternates every other column. The patch may be applied to the top of the column for even numbered columns and to the bottom of the column for odd numbered columns (top for even next column and patch left on the next column, bottom for odd current column and patch right of the current column, top for even current column and patch right on the current column, bottom for odd next column and patch left of the next column).

In some examples, visualization of the applied patches may be handled by client-side logic such as via CSS, JAVASCRIPT, or other client-side logic. Alternatively, visualization of the applied patches may be applied server-side depending on the particular configuration of the system.

FIGS. 11A-11D shows an example progression of laying out data elements in a columnar format based on a size of a display container 1110 having a container height 1111. In FIGS. 11A-11E, three node levels are shown with the same shading as shown in FIG. 3 to represent root nodes, parent nodes, and leaf nodes with reference number omitted for the root and parent nodes. Data elements representing leaf nodes are labeled 1-18 to show an example of laying out the leaf nodes in the columnar format.

Referring to FIG. 11A, the method 1100 may include laying out the elements of the presentation layer 1121 based on a columnar format in which the elements are laid out starting from the left (as intended to be perceived by a reader) of the display container 1110 in a left-most column and proceeding down the column, successively filling each row in the left-most column with a data element until there is no more space in the column. A root node has leaf nodes 4-6 in which leaf node 6 overflows the container height 1111. As such, node 6 of the root node will cause a column split. That is, the root node will be split across different columns. These split nodes may be added to a list of components to be placed in the display container 1110 with an indication of the split. For example, each of the leaf nodes will be stored with attributes such as their height and metadata to indicate that these nodes are to be visually grouped together using a patch across adjoining columns when rendering the view layer. The patch may be indicated by the same group shading, coloring, or other visual indication of a group. In particular, the patch will be rendered at a position corresponding to one of patch directions D(1)-D(4).

Referring to FIG. 11B, the leaf nodes 5 and 6 are split with a patch applied with the same shading for the group (which represents the root node to which the leaf nodes 4, 5, and 6 ultimately belong). In this way, even though the leaf nodes 5 and 6 are split across different columns, they are easily identifiable as belonging to the same root node group. In the columnar format, odd columns in the view layer may have elements laid out from up-to-down and even columns may have elements laid out from down-to-up, as illustrated in the progression of FIGS. 11A-11D. As illustrated, the ordering of elements is appropriately inverted when switching between odd and even columns. Metadata for each of the elements may be updated to reflect this ordering. For example, the margin-bottom may be transformed to a margin-top to ensure proper layout when switching from odd columns to even columns. It should be noted that a patch may not be necessary when switching to a new column, such as illustrated in FIGS. 11C and 11D.

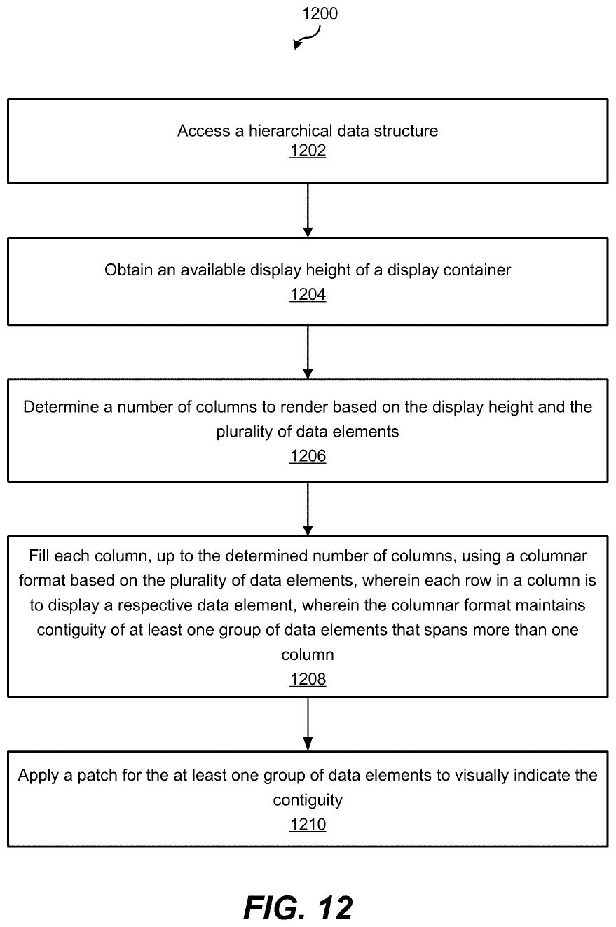

FIG. 12 illustrates an example of a method 1200 of generating a user interface display that represents a hierarchical data structure into a columnar format. At 1202, the method 1200 may include accessing a hierarchical data structure (such as a hierarchical data structure 111). In some examples, the hierarchical data structure may be accessed in various data objects or formats that convey hierarchical relationships, such as distributed arrays, native data structures, and/or other techniques. Examples of native data structures may include JAVASCRIPT Object Notation (JSON) tree data, extensible markup language (XML), and/or other built-in hierarchical ways to convey hierarchical data.

At 1204, the method 400 may include obtaining the available display height. At 1206, the method 400 may include determining a number of columns to render based on the display height and the plurality of data elements. At 1208, the method 400 may include filling each column, up to the determined number of columns, using a columnar format based on the plurality of data elements. Each row in a column is to display a respective data element and the columnar format maintains contiguity of at least one group of data elements that spans more than one column. This contiguity may be maintained through the use of a patch when the data elements cause a split such that data elements in a given group will not fit in the same column and is to be continued onto the next column. At 1210, the method 400 may include applying a patch for the at least one group of data elements to visually indicate the contiguity.

The datastores (such as hierarchical datastore 110) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

Each of the computer system 120 and devices 130 may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

The computer system 120 and the one or more devices 130 may be connected to one another via a communication network (not illustrated), such as the Internet or the Internet in combination with various other networks, like local area networks, cellular networks, or personal area networks, internal organizational networks, and/or other networks. It should be noted that the computer system 120 may transmit data, via the communication network, conveying the grid patterns and/or columnar formats one or more of the devices 130. Although not shown, the one or more devices 130 may each include one or more processors.

The systems and processes are not limited to the specific implementations described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by the computer system 120 illustrated in FIG. 1.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for rendering hierarchical data to fit on a display screen, comprising:
a processor programmed to:
access a hierarchical data structure comprising a plurality of nodes, each node connected to at least one other node via an edge, wherein the hierarchical data structure is to be rendered on a display container based on a plurality of data elements that represent the hierarchical data structure, the display container having an available display height that is available to display the plurality of data elements;
obtain the available display height;
determine a number of columns to render based on the display height and the plurality of data elements;
fill each column, up to the determined number of columns, using a columnar format based on the plurality of data elements, wherein each row in a column is to display a respective data element, wherein the columnar format maintains contiguity of at least one group of data elements that spans more than one column; and
apply a patch for the at least one group of data elements to visually indicate the contiguity.

2. The system of claim 1, wherein to determine the number of columns to render, the processor is further programmed to:
determine a total height that the plurality of data elements would occupy when rendered if the plurality of data elements were arranged in a single column with each data element from among the plurality of data elements being placed in a respective row in the single column, wherein the number of columns is based on the total width and the available display width.

3. The system of claim 1, wherein the processor is further programmed to:
determine a patch direction that defines a location at which to apply the patch.

4. The system of claim 1, wherein to fill each of the columns, the processor is programmed to:
until each of the plurality of data elements have been rendered:
fill each row in a column with a respective data element until the column no longer accommodates a next data element, wherein each data element in the column will have its own respective row in the column; and
start to fill a next column with the next data element adjacent to a previous data element that fitted the column.

5. The system of claim 4, wherein the previous data element was filled at the bottom of the column and the next data element is started at the bottom of the next column.

6. The system of claim 4, wherein the previous data element was filled at the top of the column and the next data element is started at the top of the next column.

7. The system of claim 1, wherein the processor is further programmed to:
maintain a uniform row height within each column.

8. The system of claim 1, wherein the processor is further programmed to:
maintain a uniform row height across all columns.

9. The system of claim 1, wherein the processor is further programmed to:
receive an indication that the size of the display container has changed;
obtain a new size of the display container; and
re-render the hierarchical data structure into the columnar format based on the new size.

10. The system of claim 1, wherein the processor is further programmed to:
receive an indication that the hierarchical data structure has been updated; and
re-render the updated hierarchical data structure into the columnar format based on the updated hierarchical data structure.

11. A method, comprising:
accessing, by a processor, a hierarchical data structure comprising a plurality of nodes, each node connected to at least one other node via an edge, wherein the hierarchical data structure is to be rendered on a display container based on a plurality of data elements that represent the hierarchical data structure, the display container having an available display height that is available to display the plurality of data elements;
obtaining, by the processor, the available display height;
determining, by the processor, a number of columns to render based on the display height and the plurality of data elements;
filling, by the processor, each column, up to the determined number of columns, using a columnar format based on the plurality of data elements, wherein each row in a column is to display a respective data element, wherein the columnar format maintains contiguity of at least one group of data elements that spans more than one column; and
applying, by the processor, a patch for the at least one group of data elements to visually indicate the contiguity.

12. The method of claim 11, wherein determining the number of columns to render comprises:
determining a total height that the plurality of data elements would occupy when rendered if the plurality of data elements were arranged in a single column with each data element from among the plurality of data elements being placed in a respective row in the single column, wherein the number of columns is based on the total height and the available display height and/or a maximum number of columns parameter.

13. The method of claim 11, further comprising:
determining a patch direction that defines a location at which to apply the patch.

14. The method of claim 11, wherein filling each of the columns comprises:
until each of the plurality of data elements have been rendered:
filling each row in a column with a respective data element until the column no longer accommodates a next data element, wherein each data element in the column will have its own respective row in the column; and
starting to fill a next column with the next data element adjacent to a previous data element that fitted the column.

15. The method of claim 14, wherein the previous data element was filled at the bottom of the column and the next data element is started at the bottom of the next column.

16. The method of claim 14, wherein the previous data element was filled at the top of the column and the next data element is started at the top of the next column.

17. The method of claim 11, further comprising:
maintaining a uniform row height within each column.

18. The method of claim 11, further comprising:
maintaining a uniform row height across all columns.

19. A non-transitory computer readable medium storing instructions that, when executed by a processor, programs the processor to:
access a plurality of data elements to render in a display container;
obtain an available display height of the display container;
determine a number of columns to render based on: (1) the display height and the plurality of data elements, and/or (2) a maximum number of columns specified by an input parameter;
fill each column, up to the determined number of columns, using a columnar format based on the plurality of data elements, wherein each row in a column is to display a respective data element, wherein the columnar format maintains contiguity of at least one group of data elements that spans more than one column; and
apply a patch for the at least one group of data elements to visually indicate the contiguity.

20. The computer readable medium of claim 19, wherein the plurality of data elements represent non-linear data that is transformed and rendered in the columnar format.
